(19) United States
(12) Patent Application Publication
(10) Pub. No.: US 2023/0162377 A1
(43) Pub. Date: May 25, 2023

(54) DEVICE AND METHOD FOR MEASURING VEHICLE OCCUPANT MOVED DISTANCE, AND NON-TRANSITORY COMPUTER-READABLE STORAGE MEDIUM

(71) Applicant: TOYOTA JIDOSHA KABUSHIKI KAISHA, Toyota-shi (JP)

(72) Inventor: Takahiro IZUNO, Toyota-shi (JP)

(73) Assignee: TOYOTA JIDOSHA KABUSHIKI KAISHA, Toyota-shi (JP)

(21) Appl. No.: 17/988,204

(22) Filed: Nov. 16, 2022

(30) Foreign Application Priority Data
Nov. 25, 2021 (JP) 2021-191422

(51) Int. Cl. G06T 7/246; G06T 7/66; G06V 10/26; G06V 20/59; B60Q 9/00

(52) U.S. Cl. CPC G06T 7/251; G06T 7/66; G06V 10/267; G06V 20/59; G06T 7/248; B60Q 9/00; G06T 2207/30196

(57) ABSTRACT

A vehicle occupant moved-distance measuring device includes a center estimator, a stable area setter, a start-point setter, and a moved-distance calculator. The center estimator estimates a center of an occupant represented by a target human image from frame images captured by an image capturing device. The stable area setter sets a stable area in which the estimated center obtained from a temporary reference image is placed at the center. The start-point setter sets, as a start point, a predefined point within the stable area when the start-point setter determines that the estimated center has remained within the stable area longer than a threshold based on estimated center obtained from subsequent images. The moved-distance calculator calculates a moved distance of the occupant based on a distance between the start point and an estimated center obtained from a measurement-target image.

### CROSS REFERENCE TO RELATED APPLICATION

This application claims priority to Japanese Patent Application No. 2021-191422 filed on Nov. 25, 2021, which is incorporated herein by reference in its entirety including the specification, claims, drawings, and abstract.

### TECHNICAL FIELD

The present disclosure relates to a device and a method for measuring a distance moved by a vehicle occupant (hereinafter “moved distance”), and to a non-transitory computer-readable storage medium.

### BACKGROUND

Technologies have been proposed to sense movement of vehicle occupants based on image sequences (hereinafter referred to as “frame images”) captured by an image capturing device which images the interior of a vehicle.

For example, JP 2017-199123 A discloses a passenger movement sensor system installed inside a bus. This system determines whether or not a person (passenger) is moving around on the bus by locating the person from captured images periodically output from a camera which captures the interior of the bus. When a passenger is moving around on the bus, an alarm is output to alert the driver of a need to exercise caution. JP 2015-108941 A discloses an image recognition device which obtains a distance moved by the center of a driver's face. This device obtains the center of the driver's face from respective time-sequential frame images of the driver's face output from a camera and obtains the distance moved based on the center of the driver's face obtained from the first-frame image and the second-frame image subsequent to the first-frame image.

A distance moved by an occupant (moved distance) may be obtained by locating a target human image of the occupant whose moved distance is to be measured from respective time-sequential frame images obtained by an image capturing device which captures the interior of a vehicle, and by estimating the center of the occupant based on the target human image. The moved distance may be obtained based on the distance between the center estimated in the first-frame image, which is one of the time-sequential frame images, and the second-frame image subsequent to the first-frame image.

In calculating a moved distance of a vehicle occupant in order to sense that the occupant has moved around, an image capturing the occupant before moving around (occupant remaining at one spot) serves as the first-frame image, which is the starting image from which the calculation of the moved distance is orientated. In this case, the center of the target human image (image of the occupant) in the first-frame image may be used as the start point of the moved-distance calculation.

However, occupants of a vehicle may temporarily and significantly change their posture in a manner which would not appropriately be deemed as moving around. A significant change in posture of an occupant may cause a significant change in the center of the target human image in the first-frame image. If the image of the occupant in the temporarily and significantly changed posture is used as the first-frame image, the start point of the moved-distance calculation is set at the center of the occupant in the significantly changed posture, resulting in an erroneous start point. A moved distance of the occupant calculated based on this erroneous start point may result in an inaccurate calculation of the moved distance.

An object of a vehicle occupant moved-distance measuring device according to the present disclosure is to set a start point of a moved-distance calculation based on the center of an occupant obtained when the occupant has maintained a stable posture for a time period matching or exceeding a threshold time period to calculate the moved distance of the occupant based on the center of the occupant represented by the target human images located from time sequential frame images of the interior of the vehicle.

### SUMMARY

A vehicle occupant moved-distance measuring device according to an embodiment of the present disclosure includes a center estimator, a stable area setter, a start-point setter, and a moved-distance calculator. The center estimator is configured to locate a target human image corresponding to an occupant whose moved distance is to be measured from each of the time-sequential frame images obtained by an image capturing device which captures the interior of a vehicle in a fixed image capturing area, and obtain an estimated center of the occupant based on the target human image. The stable area setter is configured to set a stable area in which an estimated center obtained from a temporary reference image is placed at the center. The temporary reference image is one of the time-sequential frame images. The start-point setter is configured to set, as a start point, a predefined point within the stable area when the start-point setter determines that the estimated center obtained from multiple subsequent images have remained within the stable area for a time period matching or exceeding a threshold time period. The multiple subsequent images are multiple time-sequential frame images following the temporary reference image. The moved-distance calculator is configured to calculate a moved distance of the occupant represented by the target human image based on a distance between the start point and an estimated center obtained from a measurement-target image which is the time-sequential frame image following the multiple subsequent images.

In this configuration, when the estimated center of the occupant has remained within the stable area for a time period matching or exceeding a threshold time period, it can be assumed that the occupant has maintained a stable posture without a significant change in their posture for the time period matching or exceeding the threshold time period after the temporary reference image was captured. This configuration can thus set, as the start point of the calculation of the occupant moved-distance, the estimated center of the occupant when the occupant has maintained a stable posture for a time period matching or exceeding a threshold time period.

When the estimated center obtained from the multiple subsequent images moves out from the stable area within the threshold time period, the stable area setter may reset the stable area using the subsequent image with the estimated center moved out from the stable area as the temporary reference image.

With this configuration, when the estimated center moves out from the stable area within the threshold time period (in other words, when the occupant has significantly changed their posture within the threshold time period after the temporary reference image was captured), the start point is not set within this stable area, but an appropriate start point is set based on a reset stable area.

The center estimator may deem the center of a circumscribed rectangle around the target human image as the estimated center.

With this configuration, the center of an occupant can be estimated using a simple process.

The vehicle may be an autonomously driven vehicle. The vehicle occupant moved-distance measuring device may further include a signal output unit configured to output a drive start disable signal which prevents the vehicle from starting through an autonomous driving when the moved distance calculated by the moved-distance calculator is equal to or longer than a threshold distance.

With this configuration, the vehicle can be prevented from starting through autonomous driving when an occupant is moving around.

The vehicle occupant moved-distance measuring device may further include a notification controller configured to control an output of a notification to the occupants of the vehicle when the moved distance calculated by the moved-distance calculator is equal to or longer than a threshold distance.

With this configuration, when an occupant is moving around, a notification can be output to the occupant and other occupants.

A non-transitory computer-readable storage medium according to an embodiment of the present disclosure stores commands executable by a computer. The commands cause the computer to execute setting a stable area, estimating a center, setting a start point, and calculating a moved distance of an occupant. The setting of a stable area is performed by locating, from a temporary reference image, a target human image corresponding to the occupant whose moved distance is to be measured. The temporary reference image is one of time-sequential frame images obtained by an image capturing device which captures the interior of a vehicle in a fixed image capturing area, and by obtaining an estimated center of the occupant based on the target human image of the temporary reference image, and further by setting the stable area in which the estimated center obtained from the temporary reference image is placed at the center. In estimating the center, the center is estimated in multiple subsequent images which are time-sequential frame images following the temporary reference image. Estimating the center is performed by locating the target human images from the multiple subsequent images, obtaining estimated centers of the occupant from the multiple subsequent images based on the target human images, and determining whether or not the estimated center has remained within the stable area for a time period matching or exceeding a threshold time period based on the estimated center obtained from the multiple subsequent images. In setting the start point, a predefined point within the stable area when the estimated center obtained from the multiple subsequent images determined to have remained within the stable area for the time period matching or exceeding the threshold time period is set as the start point. In calculating the moved distance, the moved distance of the occupant represented by the target human image is calculated by locating the target human image from a measurement-target image which is the time-sequential frame image following the multiple subsequent images, obtaining an estimated center of the occupant based on the target human image of the measurement-target image, and calculating the moved distance of the occupant represented by the target human image based on a distance between the start point and the estimated center obtained from the measurement-target image.

A vehicle occupant moved-distance measuring method according to an embodiment of the present disclosure includes setting a stable area, estimating a center, setting a start point, and calculating a moved distance. The setting of the stable area includes locating, from a temporary reference image, a target human image corresponding to an occupant whose moved distance is to be measured. The temporary reference image is one of time-sequential frame images obtained by an image capturing device which captures the interior of a vehicle in a fixed image capturing area. The setting of the stable area also includes obtaining an estimated center of the occupant based on the target human image of the temporary reference image, and setting the stable area in which the estimated center obtained from the temporary reference image is placed at the center. In estimating the center, the center in multiple subsequent images which are time-sequential frame images following the temporary reference image by locating the target human images in the multiple subsequent images is estimated, an estimated center of the occupant is obtained from the multiple subsequent images based on the target human images, and whether or not the estimated center has remained within the stable area for a time period equal to or longer than a threshold time period is determined based on the estimated center estimated from the multiple subsequent images. In setting a start point, a predefined point within the stable area is set as the start point when the estimated center obtained from the multiple subsequent images is determined to have remained within the stable area for the time period equal to or longer than the threshold time period. In calculating the moved distance, the moved distance of the occupant represented by the target human image is calculated by locating the target human image from a measurement-target image which is the time-sequential frame image following the multiple subsequent images, obtaining an estimated center of the occupant based on the target human image of the measurement-target image, and calculating the moved distance of the occupant represented by the target human image based on a distance between the start point and the estimated center obtained from the measurement-target image.

The vehicle occupant moved-distance measuring device according to the present disclosure can set, as the start point of the moved-distance calculation, a position based on the estimated center of the occupant when the occupant has maintained a stable posture for a time period matching or exceeding a threshold time period to calculate the moved distance of the occupant based on the estimated center of the occupant represented by the target human image located from each of the time-sequential frame images capturing the interior of the vehicle.

### BRIEF DESCRIPTION OF DRAWINGS

Embodiments of the present disclosure will be described based on the following figures, wherein:

FIG. 1 is a configuration block diagram of a vehicle occupant moved-distance measurement system according to an embodiment of the present disclosure;

FIG. 2 is a configuration block diagram of a vehicle occupant moved-distance measuring device according to an embodiment of the present disclosure;

FIG. 3 is an example diagram of a temporary reference image;

FIG. 4 is a first example diagram of a subsequent image;

FIG. 5 is a second example diagram of another subsequent image;

FIG. 6 is an example diagram of a measurement-target image; and

FIG. 7 is a flowchart showing processes performed by the vehicle occupant moved-distance measuring device according to an embodiment of the present disclosure.

### DESCRIPTION OF EMBODIMENTS

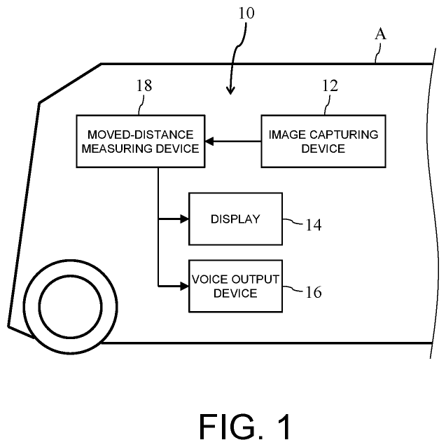

FIG. 1 is a configuration block diagram of a vehicle occupant moved-distance measurement system 10 according to an embodiment of the present disclosure. The vehicle occupant moved-distance measurement system 10 is a system to measure a moved distance of an occupant of a vehicle A. In the present embodiment, the vehicle A is a bus on which multiple passengers travel. Specifically, the vehicle A is an autonomously drivable vehicle. Autonomous driving means that almost all driving control is performed by an autonomous drive computer mounted on the vehicle A. An operator of the vehicle A may be present to perform some portion of drive control during autonomous driving. In the present specification, an occupant indicates at least one of a passenger or the operator of the vehicle A.

The moved-distance measurement system 10 includes an image capturing device 12, a display 14, a voice output device 16, and a moved-distance measuring device 18.

The image capturing device 12 may be a digital camera. That is, the image capturing device 12 may include a lens and a CCD image sensor or the like to convert the light received by the lens from an object to electric signals. The CCD image sensor may be configured with CCD elements arranged in a two-dimensional array. Each CCD element may correspond to each pixel of time-sequential frame images captured by the image capturing device 12.

The image capturing device 12 is mounted inside the vehicle A and captures the interior of the vehicle A in a fixed image capturing area to obtain time-sequential frame images. In the present embodiment, the image capturing device 12 is mounted at the ceiling of the vehicle A and the image capturing area encompasses substantially the entirety of the interior of the vehicle.

In the present embodiment, the image capturing device 12 is a video camera that captures video. When the video frame rate is, for example, 30 FPS (frame per second), the captured video consists of 30 frames per second. The image capturing device 12 is not limited to a video camera as long as the device can capture time-sequential frame images of the interior of the vehicle A. For example, the image capturing device 12 may be a still camera which intermittently captures still images as the frame images. The frame images captured by the image capturing device 12 are sequentially sent to the moved-distance measuring device 18 in the captured order (in time-sequence).

The display 14 may include, for example, digital signage or an indicator. The display 14 is provided inside the vehicle A. As described in detail below, the display 14 is used to notify the occupants of the vehicle A in response to commands from the moved-distance measuring device 18.

The voice output device 16 may be, for example, a speaker. The voice output device 16 is also provided inside the vehicle A. Similarly as the display 14, the voice output device 16 is used to notify the occupants of the vehicle Ain response to commands from the moved-distance measuring device 18.

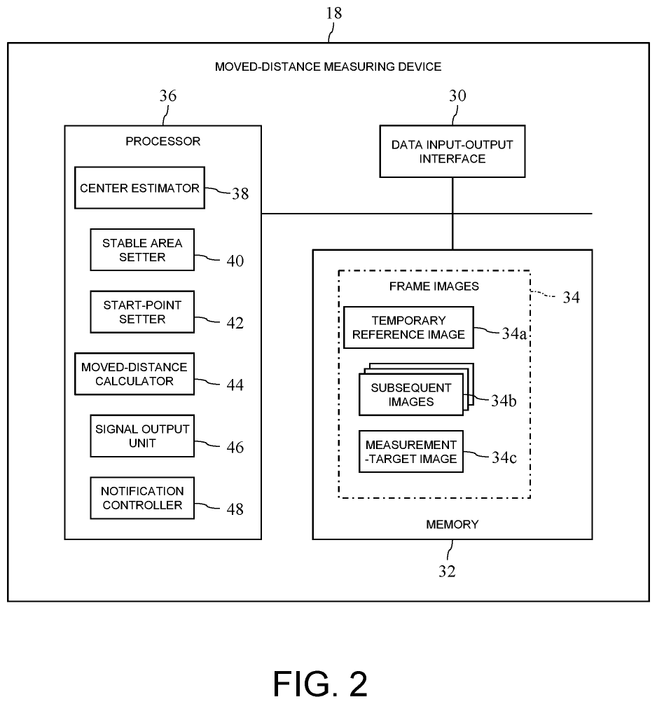

FIG. 2 is a configuration block diagram of the moved-distance measuring device 18. In the present embodiment, the moved-distance measuring device 18 is mounted on the vehicle A.

A data input-output interface 30 may include, for example, various connectors. The moved-distance measuring device 18 may be data-communicatively connected to the image capturing device 12, the display 14, the voice output device 16, and other devices via the data input-output interface 30. For example, the data input-output interface 30 may sequentially receive frame images from the image capturing device 12. The data input-output interface 30 may send command signals to the display 14 or the voice output device 16.

A memory 32 may include, for example, an embedded multimedia card (eMMC), a read only memory (ROM), or a random access memory (RAM). The memory 32 stores a moved-distance measurement program used to operate respective units of the moved-distance measuring device 18. The moved-distance measurement program may be stored in a non-transitory computer-readable storage medium, such as a universal serial bus (USB) memory or a CD-ROM. The moved-distance measuring device 18 performs the moved-distance measurement program by reading the storage medium which stores the moved-distance measurement program.

As shown in FIG. 2, the memory 32 stores time-sequential frame images 34 received from the image capturing device 12. In the present specification, the frame images 34 are distinguished in accordance with their usages. One of the frame images 34 is referred to as a temporary reference image 34a. Multiple frame images 34 subsequent to the temporary reference image 34a are referred to as subsequent images 34b. The frame image 34 following the subsequent images 34b is referred to as a measurement-target image 34c.

A processor 36 may be configured with, for example, an electronic control unit (ECU), a central processing unit (CPU), and other devices. The processor 36 is not limited to a single processing device. Multiple processing devices at physically remote locations may serve together as the processor 36. The processor 36 operates in accordance with the moved-distance measurement program stored in the memory 32 or other storage medium to provide functions as a center estimator 38, a stable area setter 40, a start-point setter 42, a moved-distance calculator 44, a signal output unit 46, and a notification controller 48. The center estimator 38 locates a target human image corresponding to the occupant whose moved distance is to be calculated from each of the frame images 34 including the temporary reference image 34a, the multiple subsequent images 34b, and the measurement-target image 34c. This locating process of the target human image from the frame images may be performed using a well-known method. For example, a background image with no occupants may be captured in advance by the image capturing device 12. The center estimator 38 may create difference images by comparing the respective frame images with the background image. The center estimator 38 may determine whether the difference images contain human images based on the sizes and shapes of objects in the difference images. The center estimator 38 may then determine whether or not the human image located in each frame image is the target occupant based on the features obtained from the human images. This process can locate the target human images corresponding to a single target occupant from the respective frame images.

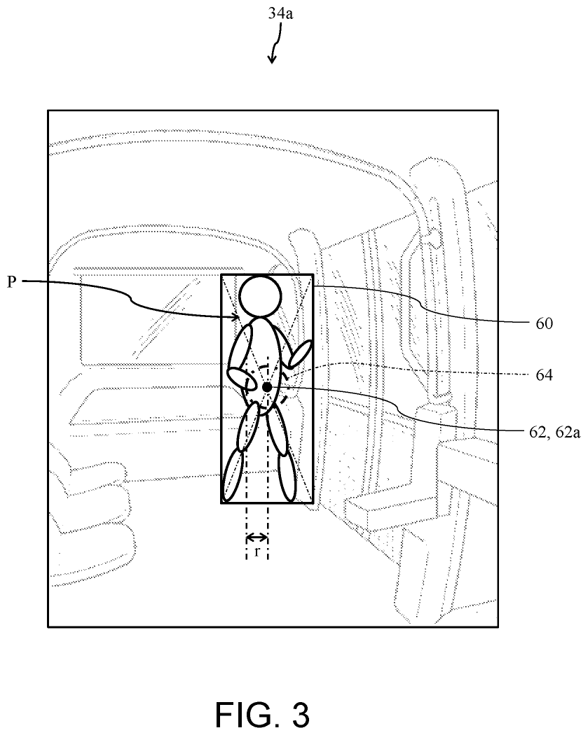

Next, the center estimator 38 estimates the center of the occupant represented by the target human image based on the located target human image in each frame image. This estimation process of the center of the target human image is described below using the processes applied to the temporary reference image 34a as an example. FIG. 3 is an example of the temporary reference image 34a. It is assumed that the target human image P has been located from the temporary reference image 34a using the above described process. In the present embodiment, the center estimator 38 initially sets a circumscribed rectangle 60 around the target human image P. The center estimator 38 then sets the center (the intersection of the diagonals of the circumscribed rectangle 60) as the estimated center 62 of the occupant represented by the target human image P. In other words, the center estimator 38 recognizes a point (defined by coordinates) in the frame image as the estimated center 62 of the occupant represented by the target human image P in the present embodiment. The estimated center 62 obtained from the temporary reference image 34a is referred to as an estimated center 62a.

Although the center estimator 38 may obtain the estimated center 62 of the occupant represented by the target human image P using another method, for example, based on the shape of the target human image P, the amount of calculation to obtain the estimated center 62 can be reduced by obtaining the estimated center 62 of the occupant in the above described simple manner. In particular, as described in detail below, in the present embodiment, because the movement of the occupant is sensed in real time by sequentially obtaining the estimated center 62 of the occupant represented by the target human image P from the frame images sequentially sent from the image capturing device 12, the estimated center 62 can be obtained in a simple manner.

In response to receipt of sequential frame images from the image capturing device 12, the center estimator 38 locates the target human image P from the received frame images and obtains the estimated center 62 of the occupant represented by the target human image P.

The stable area setter 40 sets a stable area 64 in which the estimated center 62a obtained from the temporary reference image 34a is placed at the center. In the present embodiment, as shown in FIG. 3, the stable area setter 40 sets, as the stable area 64, a circular area covering pixels in a circle of a radius r with the estimated center 62a defined by coordinates located at the center in the coordinate system of the image.

As described below, the stable area 64 is used to determine whether or not the occupant represented by the target human image P has significantly changed their posture. Specifically, it is determined that the occupant has significantly changed their posture when the estimated center 62 of the occupant represented by the target human image P in the subsequent images 34b following the temporary reference image 34a moves out from the stable area 64. The size of the stable area 64 (that is the radius r) should be determined as required by a manager or other personnel of the moved-distance measurement system 10 to allow a reasonable posture change of the occupant represented by the target human image P while enabling sensing of a significant posture change of the occupant that would result in an inaccurate calculation of the moved distance of the occupant. The stable area setter 40 may vary the radius r in accordance with the size of the target human image P in the temporary reference image 34a (for example, setting a longer distance r for a larger target human image P), because the size of the target human image P becomes larger in the temporary reference image 34a when the occupant represented by the target human image P is closer to the image capturing device 12.

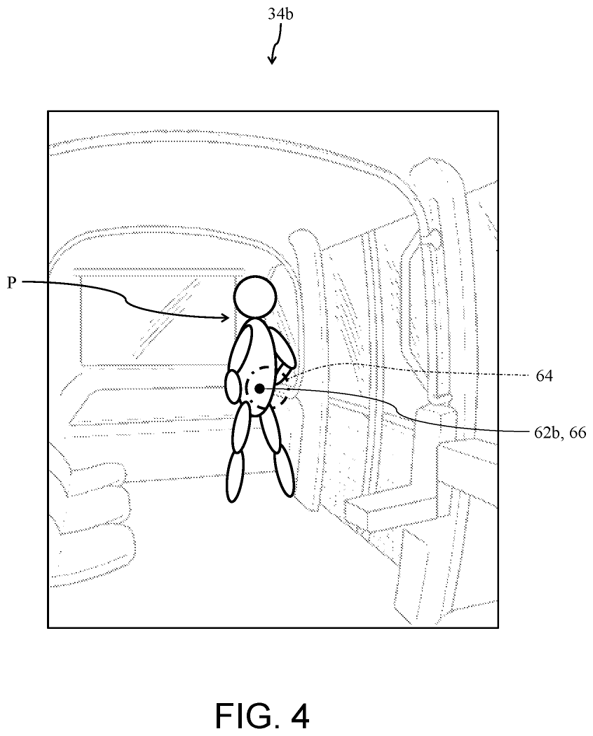

The start-point setter 42 determines whether or not the estimated center 62 of the target human image P has remained within the stable area 64 for a time period matching or exceeding a threshold time period predetermined by the manager or other personnel of the moved-distance measurement system 10 based on the estimated center 62 obtained from the multiple subsequent images 34b by the center estimator 38. The multiple subsequent images 34b are multiple time-sequential frame images following the temporary reference image 34a. FIG. 4 shows a first example of the subsequent image 34b. The estimated center 62 obtained from each of the multiple subsequent images 34b is referred to as an estimated center 62b.

In the present embodiment, the start-point setter 42 checks the multiple subsequent images 34b in a time sequential order and determines whether or not the estimated center 62b represented by the coordinates is located within the stable area 64 defined by coordinates. The start-point setter 42 determines that the estimated center 62 of the occupant represented by the target human image P have remained within the stable area 64 for a time period matching or exceeding the threshold time period when all the subsequent images 34b captured in the threshold time period have the estimated centers 62b within the stable area 64 as shown in FIG. 4. For example, the number of the subsequent images 34b may be 30 when the frame rate of the video captured by the image capturing device 12 is 30 FPS and the threshold time period is one second. This indicates that the occupant represented by the target human image P has maintained a stable posture without a significant posture change for the threshold time period after the temporary reference image 34a was captured.

When the start-point setter 42 determines that the estimated center 62 of the occupant represented by the target human image P have remained within the stable area 64 for a time period matching or exceeding the threshold time period, the start-point setter 42 sets a predefined position within the stable area 64 as a start point 66 from which the moved distance of the occupant is originated. The predefined position (that is, the start point 66) may be any arbitrary point within the stable area 64. For example, in the present embodiment, among the subsequent images 34b captured within the threshold time period, the estimated center 62 obtained from the last subsequent image 34b is used as the start point 66. The start point 66 may also be the center of the estimated centers 62 obtained from the multiple subsequent images 34b, or the center of the stable area 64 (that is, the estimated center 62a obtained from the temporary reference image 34a).

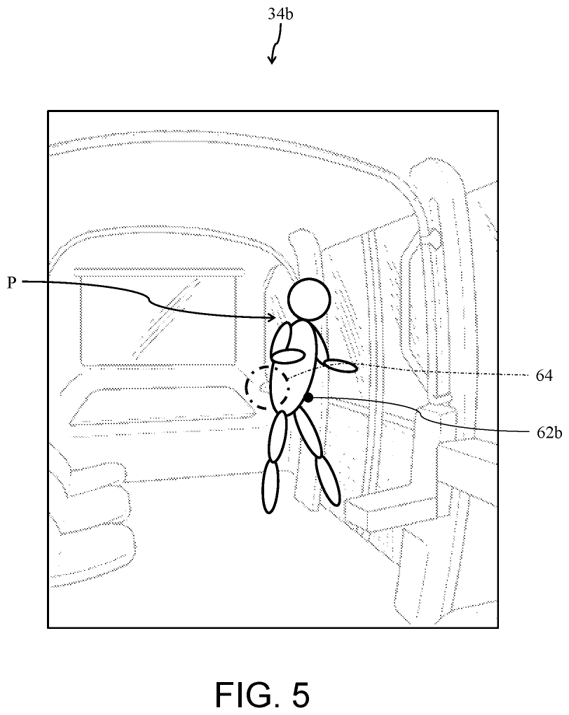

FIG. 5 shows a second example of a subsequent image 34b. As shown in FIG. 5, when the estimated center 62b obtained from any one of the subsequent images 34b captured within the threshold time period moves out from the stable area 64, in other words, when the estimated center 62b is located outside the stable area 64 within the threshold time period, it is indicated that the occupant represented by the target human image P has significantly changed their posture within the threshold time period. In such a case, the start-point setter 42 does not set the start point 66 in this stable area 64.

In this case, the stable area setter 40 resets the stable area 64 to one based on a new temporary reference image 34a using the subsequent image 34b with the estimated center 62b outside the stable area 64 as the new temporary reference image 34a. The start-point setter 42 then repeats the above described processes to the subsequent images 34b following the new temporary reference image 34a.

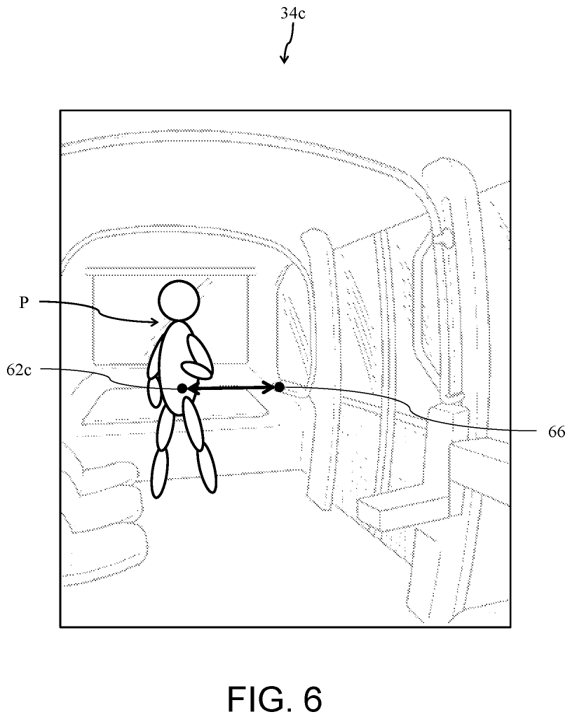

The moved-distance calculator 44 calculates the moved distance of the occupant represented by the target human image P based on the distance between the start point 66 set by the start-point setter 42 and the estimated center 62 of the measurement-target image 34c which is the time-sequential frame image following the multiple subsequent images 34b. FIG. 6 is an example of the measurement-target image 34c. The estimated center 62 obtained from the measurement-target image 34c is referred to as an estimated center 62c.

Naturally, the distance between the start point 66 and the estimated center 62c in the coordinate system of the images differs from the moved distance of the occupant represented by the target human image P in the actual space. The moved-distance calculator 44 may calculate the moved distance of the occupant represented by the target human image P in the actual space by applying correction factors to the distance between the start point 66 and the estimated center 62c in the coordinate system of the images based on the distance between the image capturing device 12 and the start point 66, the distance between the image capturing device 12 and the estimated center 62c, the angle between the direction of incident light to a CCD element of the image capturing device 12 (in other words, light corresponding to each pixel of the frame images) and the optical axis of the camera lens of the image capturing device 12, and other values. The moved-distance calculator 44 may calculate the moved distance of the occupant represented by the target human image P in the actual space by initially defining multiple specific spots on fixed objects (for example, seats and handrails) within the image capturing area of the image capturing device 12, storing in advance distances between these specific spots in the actual space in the memory 32, and referring to the distances between the specific spots in the actual space.

The distance from the image capturing device 12 to the start point 66 or to the estimated center 62c can be obtained by the processes described below. For example, as described on the webpage published on the Internet at <https://www.global.toshiba/jp/technology/corporate/rdc/rd/topics/19/1910-03.html>, an image showing distances between the image capturing device 12 and points of the image-captured objects represented by respective pixels (defined by coordinates) of the frame images can be obtained by inputting respective frame images to a distance measurement learning unit which has been already trained. The moved-distance calculator 44 can thus obtain the distance from the image capturing device 12 to the start point 66 by inputting the subsequent images 34b (or the temporary reference image 34a) to the distance measurement learning unit, or the distance from the image capturing device 12 to the estimated center 62c by inputting the measurement-target image 34c to the distance measurement learning unit.

The moved-distance calculator 44 calculates the moved distance of the occupant represented by the target human image Pin the actual space based on the measurement-target image 34c in response to receipt of the measurement-target image 34c from the image capturing device 12. The moved-distance calculator 44 determines that the occupant has moved around when the calculated moved-distance of the occupant represented by the target human image P is equal to or longer than the threshold distance which has been set by the manager or other personnel of the moved-distance measurement system 10. The threshold distance may be set to a value greater than the moved-distance of the estimated center 62 which would be caused when the occupant merely changed their posture.

When the moved-distance calculator 44 determines that the occupant represented by the target human image P has moved around, the signal output unit 46 outputs a drive start disable signal to the autonomous drive computer to prevent the vehicle A from starting through autonomous driving. Because the autonomous drive computer is prevented from starting autonomous driving of the vehicle A, starting of the vehicle A c through autonomous driving while the occupant is moving around in the vehicle can be prevented. The autonomous drive computer is able to later restart autonomous driving after the drive start disabled state is released, for example, by an operator on board the vehicle A.

When the moved-distance calculator 44 determines that the occupant represented by the target human image P has moved around, the notification controller 48 may output a notification to the occupants of the vehicle A.

Specifically, the notification controller 48 may send a notification command signal to control the display 14 to display a notification. For example, when the display 14 is a digital signage, the notification controller 48 commands to display, as a notification to the passengers, a text message “please do not move around” or the like on the digital signage, possibly with an illustration. When the display 14 is an indicator, the notification controller 48 notifies the operator that an occupant is moving around by lighting up or flashing the indicator.

The notification controller 48 may send a notification command signal to the voice output device 16 to perform a voice notification. For example, the notification controller 48 commands the voice output device 16 to output a voice message “please do not move around” as a notification to passengers. The notification controller 48 may command the voice output device 16 to output an voice message “a passenger is moving around” as a notification to the operator.

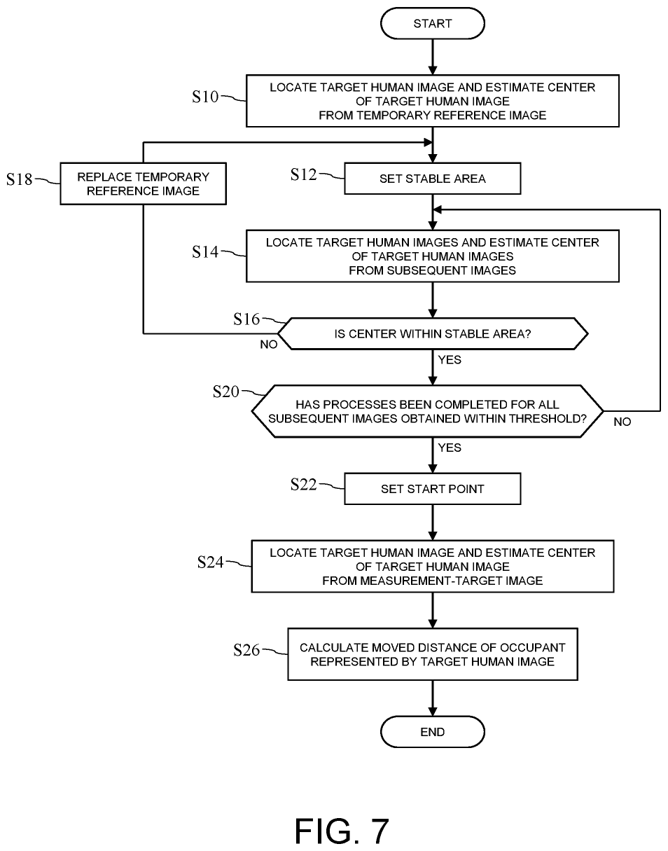

The moved-distance measurement system 10 according to embodiments of the present disclosure is outlined below. The flow of processes performed by the moved-distance measuring device 18 are described below based on the flowchart shown in FIG. 7.

In step S10, the moved-distance measuring device 18 receives the temporary reference image 34a from the image capturing device 12. The center estimator 38 locates, from the temporary reference image 34a, the target human image P corresponding to the occupant whose moved distance is to be calculated, and obtains the estimated center 62a of the occupant based on the located target human image P.

In step S12, the stable area setter 40 sets the stable area 64 in which the estimated center 62a obtained in step S10 is placed at the center. Steps S10 and S12 are referred to as the step of “setting a stable area”.

In step S14, the moved-distance measuring device 18 receives the subsequent images 34b from the image capturing device 12. The center estimator 38 locates the target human image P from the subsequent images 34b and obtains the estimated center 62b of the occupant represented by the target human image P.

In step S16, the start-point setter 42 determines whether or not the estimated center 62b represented by the coordinates obtained in step S14 is within the stable area 64 which has been set in step S12. When the estimated center 62b is outside the stable area 64, the process proceeds to step S18.

In step S18, the stable area setter 40 replaces the temporary reference image 34a with the subsequent image 34b with the estimated center 62 outside the stable area 64. Then, again in step S12, the stable area setter 40 sets the stable area 64 in the new temporary reference image 34a.

When the estimated center 62b is within the stable area 64 in step S16, the process proceeds to step S20, in which the start-point setter 42 determines whether or not the process to determine whether or not the estimated center 62b is within the stable area 64 has been performed for all the subsequent images 34b captured within the threshold time period after the temporary reference image 34a was captured. When this process has not been completed for all the subsequent images 34b captured within the threshold time period, the process returns to step S14. Again in step S14, the moved-distance measuring device 18 receives the next subsequent image 34b from the image capturing device 12, and the center estimator 38 locates the target human image P from the subsequent image 34b and obtains the estimated center 62b of the occupant represented by the target human image P. When the process has been completed for all the subsequent images 34b captured within the threshold time period, the process proceeds to step S22. Steps S14, S16, and S20 are collectively referred to as the step of “estimating the center”.

In step S22, the start-point setter 42 sets, as the start point 66, a predefined position within the stable area 64 which has been set in step S12. Step S22 is referred to as the step of “setting the start point”.

In step S24, the moved-distance measuring device 18 receives the measurement-target image 34c from the image capturing device 12. The center estimator 38 locates the target human image P from the measurement-target image 34c, and obtains the estimated center 62c of the occupant represented by the target human image P.

In step S26, the moved-distance calculator 44 calculates the moved distance of the occupant represented by the target human image P in the actual space based on the distance between the start point 66 and the estimated center 62c. Step S26 is referred to as the step of “calculating the moved distance”. When the moved distance of the occupant calculated by the moved-distance calculator 44 is equal to or longer than the threshold distance, the signal output unit 46 outputs, to the autonomous drive computer, the drive start disable signal to prevent the vehicle A from starting through autonomous driving. Further, when the moved distance of the occupant calculated by the moved-distance calculator 44 is equal to or longer than the threshold distance, the notification controller 48 controls the display 14 and/or the voice output device 16 to output a notification to the occupants of the vehicle A.

Although the vehicle occupant moved-distance measuring device according to embodiments of the present disclosure are described above, the device is not limited to the above embodiments. Various changes are applicable without deviating from the scope of the present disclosure.

For example, although in the embodiments described above the moved-distance measuring device 18 is mounted inside the vehicle A, the moved-distance measuring device 18 may be a computer external to the vehicle A (for example, a server computer). In such a case, the frame images captured by the image capturing device 12 are sequentially sent to the moved-distance measuring device 18 via communication lines, and the moved-distance measuring device 18 calculates the moved distance of the occupant of the vehicle A using the above described processes based on the image frames received via the communication lines.

1. A vehicle occupant moved-distance measuring device comprising:
a center estimator configured to
locate a target human image corresponding to an occupant whose moved distance is to be measured from each of time-sequential frame images obtained by an image capturing device which captures interior of a vehicle in a fixed image capturing area, and
obtain an estimated center of the occupant based on the target human image;
a stable area setter configured to set a stable area in which an estimated center obtained from a temporary reference image is placed at a center, the temporary reference image being one of the time-sequential frame images;
a start-point setter configured to set, as a start point, a predefined point within the stable area when the start-point setter determines that the estimated center obtained from a plurality of subsequent images have remained within the stable area for a time period matching or exceeding a threshold time period, the plurality of subsequent images being a plurality of time-sequential frame images following the temporary reference image; and
a moved-distance calculator configured to calculate a moved distance of the occupant represented by the target human image based on a distance between the start point and an estimated center obtained from a measurement-target image which is the time-sequential frame image following the plurality of subsequent images.

2. The vehicle occupant moved-distance measuring device according to claim 1, wherein
when the estimated center obtained from the plurality of subsequent images moves out from the stable area within the threshold time period, the stable area setter resets the stable area using the subsequent image with the estimated center moved out from the stable area as the temporary reference image.

3. The vehicle occupant moved-distance measuring device according to claim 1, wherein
the center estimator deems a center of a circumscribed rectangle around the target human image as the estimated center.

4. The vehicle occupant moved-distance measuring device according to claim 1, wherein
the vehicle is an autonomously driven vehicle, and
the vehicle occupant moved-distance measuring device further comprises a signal output unit configured to output a drive start disable signal preventing the vehicle from starting through an autonomous driving when the moved distance calculated by the moved-distance calculator is equal to or longer than a threshold distance.

5. The vehicle occupant moved-distance measuring device according to claim 1, further comprising:
a notification controller configured to control an output of a notification to occupants of the vehicle when the moved distance calculated by the moved-distance calculator is equal to or longer than a threshold distance.

6. A non-transitory computer-readable storage medium in which commands executable by a computer are stored, wherein the commands cause the computer to execute:
setting a stable area by
locating, from a temporary reference image, a target human image corresponding to an occupant whose moved distance is to be measured, the temporary reference image being one of time-sequential frame images obtained by an image capturing device which captures interior of a vehicle in a fixed image capturing area,
obtaining an estimated center of the occupant based on the target human image of the temporary reference image,
setting the stable area in which the estimated center obtained from the temporary reference image is placed at a center;
estimating a center in a plurality of subsequent images which are time-sequential frame images following the temporary reference image by
locating the target human images from the plurality of subsequent images,
obtaining an estimated center of the occupant from the plurality of subsequent images based on the target human images,
determining whether or not the estimated center has remained within the stable area for a time period matching or exceeding a threshold time period based on the estimated center obtained from the plurality of subsequent images;
setting, as a start point, a predefined point within the stable area when the estimated center obtained from the plurality of subsequent images is determined to have remained within the stable area for the time period matching or exceeding the threshold time period; and
calculating the moved distance of the occupant represented by the target human image by
locating the target human image from a measurement-target image which is the time-sequential frame image following the plurality of subsequent images,
obtaining an estimated center of the occupant based on the target human image of the measurement-target image, and
calculating the moved distance of the occupant represented by the target human image based on a distance between the start point and the estimated center obtained from the measurement-target image.

7. A vehicle occupant moved-distance measuring method comprising:
setting a stable area by
locating, from a temporary reference image, a target human image corresponding to an occupant whose moved distance is to be measured, the temporary reference image being one of time-sequential frame images obtained by an image capturing device which captures interior of a vehicle in a fixed image capturing area,
obtaining an estimated center of the occupant based on the target human image of the temporary reference image,
setting the stable area in which the estimated center obtained from the temporary reference image is placed at a center;
estimating a center in a plurality of subsequent images which are time-sequential frame images following the temporary reference image by
locating the target human images from the plurality of subsequent images,
obtaining an estimated center of the occupant from the plurality of subsequent images based on the target human images, and
determining whether or not the estimated center has remained within the stable area for a time period matching or exceeding a threshold time period based on the estimated center obtained from the plurality of subsequent images;
setting, as a start point, a predefined point within the stable area when the estimated center obtained from the plurality of subsequent images is determined to have remained within the stable area for the time period matching or exceeding the threshold time period; and
calculating the moved distance of the occupant represented by the target human image by
locating the target human image from a measurement-target image which is the time-sequential frame image following the plurality of subsequent images,
obtaining an estimated center of the occupant based on the target human image of the measurement-target image, and
calculating the moved distance of the occupant represented by the target human image based on a distance between the start point and the estimated center obtained from the measurement-target image.
